(19) United States
(12) Patent Application Publication
(10) Pub. No.: US 2005/0129434 A1
(43) Pub. Date: Jun. 16, 2005

(54) Fusing roller apparatus of electro-photographic image forming apparatus, and a process of manufactuing a fusing roller apparatus

(76) Inventor: Hwan-guem Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/002,103

(22) Filed: Dec. 3, 2004

(30) Foreign Application Priority Data
Dec. 15, 2003 (KR) 2003-91176

(51) Int. Cl. G03G 15/20

(52) U.S. Cl. 399/330; 399/333

(57) ABSTRACT

A fusing roller apparatus, and a process of manufacturing thereof, of an electro-photographic image forming apparatus including a cylindrical internal pipe, a fusing unit which is installed to enclose the internal pipe, a heat generator which is installed between the fusing unit and the internal pipe to generate heat, and an insulating layer which includes a first insulating layer that is formed between the heat generator and the fusing unit and a second insulating layer that is formed between the heat generator and the internal pipe to be thicker than the first insulating layer.

### BACKGROUND OF THE INVENTION

This application claims the benefit under 35 U.S.C. §119(a) of Korean Patent Application No. 2003-91176, filed on Dec. 15, 2003, in the Korean Intellectual Property Office, the entire disclosure of which is incorporated herein by reference.

1. Field of the Invention

The present invention relates to an electro-photographic image forming apparatus, and more particularly, the present invention relates to a fusing roller apparatus, and a process of manufacturing thereof, of an electro-photographic image forming apparatus for applying heat and pressure to a toner image to fuse and fix the toner image to printing paper.

2. Description of the Related Art

In general, electro-photographic image forming apparatuses include a fusing roller apparatus that applies heat and pressure to a toner image transferred to a printing medium so as to fuse and fix the toner image to the printing medium.

FIG. 1 is a lateral schematic cross-sectional view of a fusing roller apparatus of a conventional electro-photographic image forming apparatus using a halogen lamp as a heat source, and FIG. 2 is a longitudinal cross-sectional view for showing the relationship between the fusing roller apparatus and a pressure roller of the conventional electro-photographic image forming apparatus of FIG. 1.

Referring to FIG. 1, a fusing roller apparatus 10 includes a fusing roller 10 of pipe type and a heat generator 12 which is installed in the inner center of the fusing roller 11 and made of a halogen lamp. A coated layer 11a is formed of Teflon on the surface of the fusing roller 11. The heat generator 12 generates radiant heat inside the fusing roller 11, and the fusing roller 11 is heated by the radiant heat transmitted from the heat generator 12.

Referring to FIG. 2, a pressure roller 13 is located below the fusing roller apparatus 10, and printing paper 14 is interposed between the fusing roller apparatus 10 and the pressure roller 13. The pressure roller 13 is elastically supported by a spring assembly 13a to press the printing paper 14 passing between the fusing roller apparatus 10 and the pressure roller 13 against the fusing roller apparatus 10 by a predetermined force.

As the printing paper 14 carries a toner image 14a in a powder form between the fusing roller apparatus 10 and the pressure roller 13, the printing paper 14 is hot-pressed by the predetermined force. In other words, the toner image 14a is fused and fixed to the printing paper 14 by the heat and force from the fusing roller apparatus 10 and the pressure roller 13.

A conventional fusing roller apparatus using a halogen lamp as a heat source unnecessarily consumes a large amount of power. Thus, in a standby mode where the operation of a printer is suspended, the conventional fusing roller apparatus must be powered down to lower a temperature. In particular, the conventional fusing roller apparatus requires considerably long warm-up time until it reaches a target fusing temperature after power is turned on for a printing operation.

The time from when power is applied to when the conventional fusing roller apparatus reaches the target fusing temperature is called First-Print-Out-Time (FPOT). The conventional fusing roller apparatus requires a FPOT from tens of seconds to tens of minutes.

In the conventional fusing roller apparatus, a fusing roller is heated by radiant heat from the heat source, which results in a slow heat transfer speed. In particular, compensation for temperature variations due to a drop in the temperature of the fusing roller caused by contact with printing paper is delayed, so that it is difficult to uniformly control the distribution of temperature along the axial length of the fusing roller.

Also, even in the standby mode where the operation of the printer is suspended, power must be periodically applied to the heat source to keep the temperature of the fusing roller constant, thereby causing unnecessary power consumption. Moreover, it takes a considerable amount of time to switch the fusing roller from its standby mode to an operation mode for image output, so that the resultant image cannot be rapidly printed.

### SUMMARY OF THE INVENTION

The present invention provides a fusing roller apparatus of an electro-photographic image forming apparatus which consumes a small amount of current and power, increases a temperature of a fusing roller to a target fusing temperature within a short period of time, and has a good insulation characteristic.

According to an aspect of the present invention, there is provided a fusing roller apparatus, and a process of manufacturing thereof, of an electro-photographic image forming apparatus, the fusing roller apparatus including: a cylindrical internal pipe; a fusing unit which is installed to enclose the internal pipe; a heat generator which is installed between the fusing unit and the internal pipe to generate heat; and an insulating layer which includes a first insulating layer that is formed between the heat generator and the fusing unit and a second insulating layer that is formed between the heat generator and the internal pipe to be thicker than the first insulating layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a lateral schematic cross-sectional view of a fusing roller apparatus of a conventional electro-photographic image forming apparatus using a halogen lamp as a heat source;

FIG. 2 is a longitudinal cross-sectional view for showing the relationship between the fusing roller apparatus and a pressure roller of the conventional electro-photographic image forming apparatus of FIG. 1;

FIG. 3 is a longitudinal schematic cross-sectional view of a fusing roller apparatus of an electro-photographic image forming apparatus, according to an embodiment of the present invention;

FIG. 4 is a lateral schematic cross-sectional view of the fusing roller apparatus of the electro-photographic image forming apparatus of FIG. 3; and

FIG. 5 is a magnified view of portion “C” of FIG. 4.

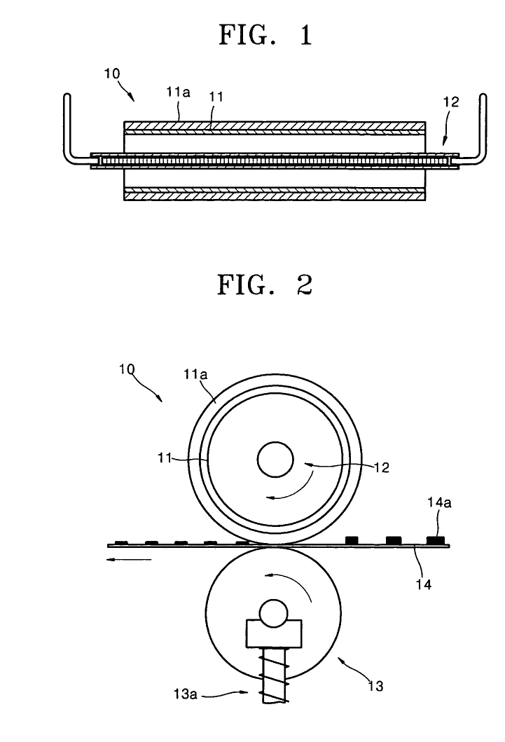

Throughout the drawings it should be understood that like reference numbers are used to depict like features and structures.

### DETAILED DESCRIPTION OF THE EXAMPLARY EMBODIMENTS

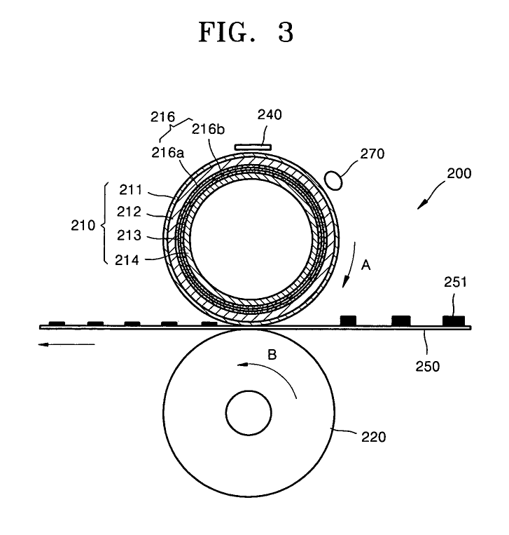

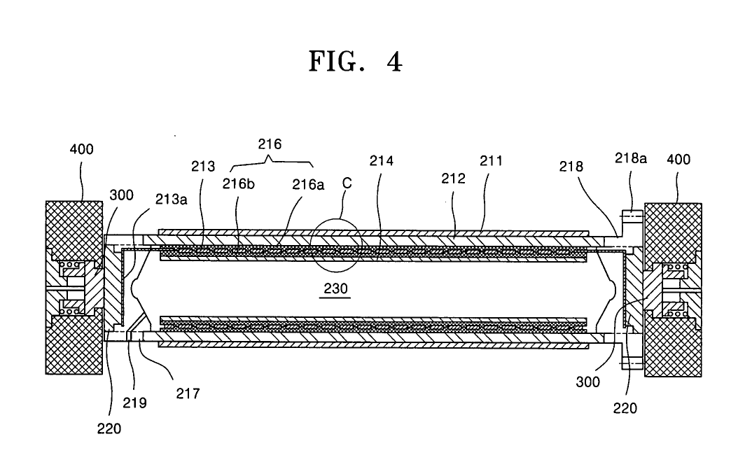

Referring to FIGS. 3 and 4, a fusing roller apparatus 200 of an electro-photographic image forming apparatus, according to an embodiment of the present invention, applies heat and pressure to a toner image 251 to fuse and fix the toner image 251 to printing paper 250. The fusing roller apparatus 200 includes a fusing roller 210 which is installed to rotate in a direction indicated by arrow “A” so as to apply heat to the toner image 251 and a pressure roller 220 which faces the fusing roller 210 to press the toner image 251 against the fusing roller 210. Here, the printing paper 250 is transferred between the fusing roller 210 and the pressure roller 220.

The fusing roller 210 includes a cylindrical fusing unit 212, an internal pipe 214, a heat generator 213, and an insulating layer 216. A protection layer 211, which is coated with Teflon, is formed on the surface of the fusing unit 212. The internal pipe 214 is installed inside the fusing unit 212 and has two ends that are opened. The heat generator 213 is installed between the fusing unit 212 and the internal pipe 214 to helically enclose the internal pipe 214 and is supplied with a current from an external power supply to generate heat. The insulating layer 216 encloses the heat generator 213 to insulate the fusing unit 212 from the internal pipe 214 so that during application of the current to the heat generator 213, a leakage current does not flow and insulation breakdown does not occur.

The fusing unit 212 and the internal pipe 214 are heated by the heat transmitted from the heat generator 213 so as to fuse and fix the toner image 251 to the printing paper 250. The fusing unit 212 and the internal pipe 214 may be formed of stainless steel, aluminum (Al), copper (Cu), or the like.

It is preferable that the heat generator 213 is formed of a resistive heating coil which is supplied with the current from the external power supply to generate heat and includes a lead 213 a which extends from both ends thereof so as to be supplied with the current from the external power supply.

The insulating layer 216 includes a first insulating layer 216a which is interposed between the fusing unit 212 and the heat generator 213 and a second insulating layer 216b which is interposed between the heat generator 213 and the internal pipe 214.

It is preferable that the insulating layer 216 is formed of a magnesium oxide (MgO) sheet or a glass sheet. The heat generated by the heat generator 213 is transmitted to the fusing unit 212 through the first insulating layer 216a and to the internal pipe 214 through the second insulating layer 216b.

The heat transmitted to the internal pipe 214 is not used to increase a temperature of the fusing unit 212. Thus, instead of transmitting a smaller amount of heat to the internal pipe 214, a larger amount of heat must be transmitted to the fusing unit 212 to reduce FPOT.

It is preferable that the second insulating layer 216b is thicker than the first insulating layer 216a. Also, it is preferable that the first insulating layer 216a is formed of a twofold MgO sheet or a twofold glass sheet and the second insulating layer 216b is formed of a threefold MgO sheet or a threefold glass sheet.

Since the MgO sheet or the glass sheet has the thickness of less than 0.1 mm, it is preferable that the first insulating layer 216a has the thickness of less than 0.2 mm and the second insulating layer 216b has the thickness of less than 0.3 mm.

An insulating material used for the insulating layer 216 has withstand voltage and insulation breakdown characteristics. The withstand voltage characteristic indicates a property of withstanding predetermined external power. The withstand insulation breakdown chracteristic indicates that a leakage current flows not to be more than 10 mA at a maximum withstand voltage for a minute, and thus insulation breakdown does not occur.

TABLE 1

| Number of | | Withstand |
|---|---|---|
| Times | Manufacturing Specifications | Voltage (kV) |
| 1 | MgO (0.1t × 40 mm × 40 mm) | 3.57 |
| 2 | MgO (0.1t × 40 mm × 40 mm) | 3.41 |
| 3 | MgO (0.1t × 40 mm × 40 mm) | 3.38 |
| 4 | MgO (0.1t × 40 mm × 40 mm) | 3.67 |
| 5 | MgO (0.1t × 40 mm × 40 mm) | 3.75 |
| 6 | MgO (0.1t × 40 mm × 40 mm) | 3.83 |
| 7 | MgO (0.1t × 40 mm × 40 mm) | 3.73 |
| 8 | MgO (0.1t × 40 mm × 40 mm) | 3.32 |
| 9 | MgO (0.1t × 40 mm × 40 mm) | 3.63 |
| 10 | MgO (0.1t × 40 mm × 40 mm) | 3.56 |

Table 1 shows the results of a withstand voltage test which was performed in conditions that a voltage was applied to an MgO sheet having the thickness of 0.1 t. Since the MgO sheet withstood a minimum voltage of 3.32 kV and a maximum voltage of 3.83 kV, a rated withstand voltage was determined to be more than 3 kV. Thus, the MgO sheet was viewed as satisfying the withstand voltage characteristic.

Thereafter, the rated withstand voltage of 3 kV was applied to the MgO sheet to check whether a leakage current was generated for a minute. The leakage current of 5 mA was generated for a minute and insulation breakdown did not occur. As a result, the MgO sheet satisfied the withstand insulation breakdown characteristic.

An end cap 217 and a power transmission end cap 218 are installed at both ends of the fusing roller 210, respectively. The power transmission end cap 218 has a similar structure to the end cap 217. However, the power transmission end cap 218 includes a power transmission portion 218 a, such as gear, which is connected to a power transmission device (not shown) installed in a frame 400, which supports the fusing roller 210, so as to rotate the fusing roller 210.

An air vent 219 is formed in the end cap 217 and allows air to flow from the outside into an inner space 230 of the fusing roller 210 after the end cap 217 is installed at the fusing roller 210 so as to maintain a pressure of the inner space 230 of the fusing roller 210 to an atmospheric pressure.

Although the internal pipe 214 is heated by the heat transmitted from the heat generator 213, the inner space 230 is kept at the atmospheric pressure due to the flow of air from the outside into the inner space 230 via the air vent 219. The air vent 219 may also be formed in the power transmission end cap 218 or may be formed in both the end cap 217 and the power transmission end cap 218.

Electrodes 220 are installed at the end cap 217 and the power transmission end cap 218, respectively, and electrically connected to the lead 213a. The current supplied by the external power supply is transmitted to the heat generator 213 through a power supply 300, the electrodes 220, and the lead 213a.

A thermostat 240 and a thermistor 270 are installed above the fusing roller 210. The thermostat 240 prevents the fusing unit 212 from being overheated by cutting off power when the surface temperatures of the fusing unit 212 and the protection layer 211 sharply increase. The thermistor 270 senses the surface temperatures of the fusing unit 212 and the protection layer 211.

A process of manufacturing the fusing roller 210 will now be explained.

The second insulating layer 216b is formed to enclose the outer surface of the internal pipe 214. Next, the heat generator 213 is helically installed to enclose the second insulating layer 216b. Thereafter, the first insulating layer 216a is formed to enclose the heat generator 213.

The internal pipe 214 on which the heat generator 213, the first insulating layer 216a, and the second insulating layer 216b have been prepared is inserted into the fusing unit 212, the outer surface of which is coated with Teflon.

Both ends of the internal pipe 214 are hermetically sealed by an expanding apparatus, and then a predetermined pressure is applied to the inner space 230 to expand the internal pipe 214. Here, it is preferable that the predetermined pressure is more than an air pressure of 140 mb.

The internal pipe 214 is expanded, the fusing unit 212 remains circular, and the heat generator 213 and the insulating layer 216 are plastically deformed. As a result, the heat generator 213, the internal pipe 214, the first insulating layer 216a, and the second insulating layer 216b adhere closely to the inner surface of the fusing unit 212.

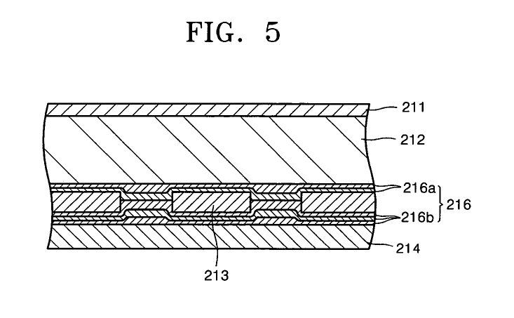

In other words, as shown in FIG. 5, since the heat generator 213 is formed of a resistive heating coil, a space between adjacent portions of the resistive heating coil is fully filled with the first and second insulating layers 216a and 216b when the internal pipe 214 is expanded.

However, when the predetermined pressure is less than the air pressure of 140 mb, the first and second insulating layers 216a and 216b do not fully fill the space between the adjacent portions of the resistive heating coil when the internal pipe 214 is expanded. An air gap is formed in the space between the adjacent portions of the resistive heating coil. The incomplete adhesion among the fusing unit 212, the heat generator 213, and the internal pipe 214 may result in forming an air gap. The air gap deteriorates heat transfer efficiency from the heat generator 213 to the fusing unit 212, which causes an increase in FPOT.

As described above, a fusing roller apparatus of an electro-photographic image forming apparatus according to the present invention can use an insulator having high withstand voltage and insulation breakdown characteristics to minimum the thickness of an insulating layer. Also, the fusing roller apparatus can allow a larger amount of heat to be transmitted to a fusing unit, which results in reducing FPOT.

While the present invention has been particularly shown and described with reference to exemplary embodiments thereof, it will be understood by those of ordinary skill in the art that various changes in form and details may be made therein without departing ftom the spirit and scope of the present invention as defined by the following claims.

1. A fusing roller apparatus of an electro-photographic image forming apparatus comprising:
an inner roller;
an outer roller which is installed to enclose the inner roller;
a heat generator which is installed between the outer roller and the inner roller to generate heat;
a first insulating layer located between the heat generator and the outer roller; and
a second insulating layer located between the heat generator and the inner roller;
wherein the second insulating layer is thicker than the first insulating layer.

2. The fusing roller apparatus of claim 1, wherein the first insulating layer comprises a twofold insulating sheet, and the second insulating layer comprises a threefold insulating sheet.

3. The fusing roller apparatus of claim 1, wherein at least one of the first insulating layer and the second insulating layer comprises a magnesium oxide sheet.

4. The fusing roller apparatus of claim 1, wherein at least one of the first insulating layer and the second insulating comprises a glass sheet.

5. The fusing roller apparatus of claim 3, wherein a thickness of the first insulating layer is less than 0.2 mm, and a thickness of the second insulating layer is less than 0.3 mm.

6. The fusing roller apparatus of claim 2, wherein at least one of the first insulating layer and the second insulating layer comprises a magnesium oxide sheet.

7. The fusing roller apparatus of claim 2, wherein at least one of the first insulating layer and the second insulating layer comprises a glass sheet.

8. The fusing roller apparatus of claim 4, wherein a thickness of the first insulating layer is less than 0.2 mm, and a thickness of the second insulating layer is less than 0.3 mm.

9. The fusing roller apparatus as claimed in claim 1, wherein the heat generator comprises:
a resistive heating coil supplied with a current from an external power supply; and
a lead which extends from at least one end of the resistive heating coil for coupling to the external power supply.

10. The fusing roller apparatus as claimed in claim 1, wherein the heat generator comprises a structure helically enclosing the inner roller.

11. The fusing roller apparatus of claim 1, further comprising:
an inner space inside the inner roller; and
an air vent which allows air to flow between an exterior of the inner space and an interior of the inner space;
whereby a pressure of the inner space is maintained substantially equal to an atmospheric pressure.

12. A process of manufacturing a fusing roller apparatus of an electro-photographic image forming apparatus, the process comprising:
forming an inner roller;
forming a second insulating layer on an outer surface of the inner roller;
installing a heating element on the second insulating layer;
forming a first insulating layer to enclose the heating element;
inserting the inner roller having the second insulating layer, the heating element and the first insulating layer into an interior of an outer roller; and
radially expanding the inner roller, whereby the inner roller, the second insulating layer, the heating element and the first insulating layer adhere to an inner surface of the outer roller.

13. The process as claimed in claim 12, wherein, when the inner roller is radially expanded, at least one of the second insulating layer, the heating element and the first insulating layer is plastically deformed.

14. The process as claimed in claim 12, wherein the heating element comprises a resistive heating coil.

15. The process as claimed in claim 14, wherein, when the inner roller is radially expanded, a space between adjacent portions of the resistive heating coil is filled with at least one of the first insulating layer and the second insulating layer.

16. The process as claimed in claim 12, wherein the second insulating layer is thicker than the first insulating layer.

17. The process as claimed in claim 12, wherein the forming of the first insulating layer comprises forming a twofold insulating sheet, and the forming of the second insulating layer comprises forming a threefold insulating sheet.

18. The process as claimed in claim 12, wherein at least one of the first insulating layer and the second insulating layer comprises a magnesium oxide sheet.

19. The process as claimed in claim 12, wherein at least one of the first insulating layer and the second insulating layer comprises a glass sheet.

20. The process as claimed in claim 12, wherein a thickness of the first insulating layer is less than 0.2 mm, and a thickness of the second insulating layer is less than 0.3 mm.

21. The process as claimed in claim 12, further comprising forming an air vent which allows air to flow between an exterior of the inner roller and an interior of the inner roller;
whereby a pressure of the interior of the cylindrical inner roller is maintained substantially equal to an atmospheric pressure.

22. The process as claimed in claim 12, wherein the installing of the heating elements comprises helically installing the heating element.
